(19) United States
(12) Patent Application Publication
(10) Pub. No.: US 2017/0279895 A1
(43) Pub. Date: Sep. 28, 2017

(54) INFORMATION PROCESSING SYSTEM AND INFORMATION PROCESSING METHOD

(71) Applicant: FUJITSU LIMITED, Kawasaki-shi (JP)

(72) Inventors: Youichi EHARA, Hiratsuka (JP); Takehiro IDE, Mishima (JP)

(73) Assignee: FUJITSU LIMITED, Kawasaki-shi (JP)

(21) Appl. No.: 15/459,559

(22) Filed: Mar. 15, 2017

(30) Foreign Application Priority Data
Mar. 23, 2016 (JP) 2016-057853

(51) Int. Cl. H04L 29/08; H04L 29/06

(52) U.S. Cl. CPC H04L 67/14; H04L 67/42; H04L 67/10

(57) ABSTRACT

An information processing system comprising a memory, and a processor coupled to the memory and configured to receive requests from a plurality of client apparatuses, store, in the memory, information about sessions established to communicate with the plurality of client apparatuses, store, in the memory, a request in response to which processing has not yet been started, the request being one of the requests received from the plurality of client apparatuses, detect a session during which a predetermined time-out time has elapsed in a state in which processing demanded by a request corresponding to the session is not being executed, the session being one of the sessions, information about the sessions being stored in the memory, and suppress, when a request received from a client apparatus corresponding to the detected session is stored in the memory, invalidation of the session due to an elapse of the time-out time.

### CROSS-REFERENCE TO RELATED APPLICATION

This application is based upon and claims the benefit of priority of the prior Japanese Patent Application No. 2016-057853, filed on Mar. 23, 2016, the entire contents of which are incorporated herein by reference.

### FIELD

The embodiments discussed herein are related to an information processing system and an information processing method.

### BACKGROUND

In a system in which a server and a client apparatus are interconnected through a network, the server performs processing in response to a request from the client apparatus. In this case, a session established between the server and the client apparatus is used to manage communication between them.

Some known technologies manage communication between a client apparatus and a server. In an example of these technologies, while processing is being executed in response to a request transmitted from the web server, a request transmitted from a web browser is not invalidated (see Japanese Laid-open Patent Publication No. 2011-008542, for example). In another technology, a server references an access history recoded in another server, and if the server confirms that a client terminal is accessing the other server, adjusts a time-out time determined for an application in the server (see Japanese Laid-open Patent Publication No. 2006-146298, for example). In another technology, a communication apparatus that transfer packets on a network has a queue in which packets to be transferred are accumulated in the order of their transfer;, packets in the queue are rearranged so that packet belonging to a communication session with a shorter reciprocal delay time is transferred more preferentially (see Japanese Laid-open Patent Publication No. 2014-147019, for example).

### SUMMARY

According to an aspect of the invention, an information processing system comprising a memory, and a processor coupled to the memory and configured to receive requests from a plurality of client apparatuses, store, in the memory, information about sessions established to communicate with the plurality of client apparatuses, store, in the memory, a request in response to which processing has not yet been started, the request being one of the requests received from the plurality of client apparatuses, detect a session during which a predetermined time-out time has elapsed in a state in which processing demanded by a request corresponding to the session is not being executed, the session being one of the sessions, information about the sessions being stored in the memory, and suppress, when a request received from a client apparatus corresponding to the detected session is stored in the memory, invalidation of the session due to an elapse of the time-out time.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of the system structure of an information processing system;

FIG. 2 illustrates an example of the hardware structure of a server;

FIG. 3 illustrates an example of a functional block diagram of the information processing system;

FIG. 4 illustrates a session established between a client apparatus and the server;

FIG. 5 illustrates an example of a functional block diagram of the server;

FIGS. 6A to 6C illustrate examples of a relationship between an order in which queued requests are processed and a session storage area;

FIG. 7 illustrates an example of a queuing processing unit;

FIG. 8 illustrates an example of a time-out time management table;

FIG. 9 illustrates an example of a session management table;

FIG. 10A is a flowchart illustrating an example of web server processing, and FIG. 10B is a flowchart illustrating an example of application server processing;

FIG. 11 is a flowchart illustrating an example of accepted session ID writing processing;

FIG. 12 is a flowchart illustrating an example of application processing;

FIG. 13 is a flowchart illustrating an example of accepted session ID deletion processing;

FIG. 14 is a flowchart illustrating an example of session time-out monitoring processing; and

FIG. 15 is a flowchart illustrating an example of queue read-out control processing.

### DESCRIPTION OF EMBODIMENTS

Due to the widespread use of the Internet of Things (IoT) technology, with which various devices on the client side are connected to the Internet and exchange information with application servers and other types of servers, many client apparatuses are connected to servers. For example, many requests are transmitted from home electrical appliances in households, sensors attached to various facilities, and other devices to servers. In this situation, although the number of sessions established between servers and client apparatuses was, for example, several hundreds to several tens of thousands in the past, now it is assumed that that number may reach several millions to several tens of millions.

In general, an application server only intermittently receives requests from individual client apparatuses, so the application server accepts requests from client apparatuses in a state in which more sessions than the number of requests that the application server can processes simultaneously have been started. Therefore, in a state in which sessions have been established with many client apparatuses, a situation may be generated in which the application server receives many requests from client apparatuses at one moment.

If, for example, popularity voting or the like is conducted in a hit program distributed to television sets connected to a network, to transmit voted data entered by audiences, requests are transmitted simultaneously from television terminals to a server that processes the voted data for the television program. In another example, if tickets of a concert of a popular musician are put on sale on the Internet, many requests concerning ticket purchases concentrate on a server that performs processing related to the selling of tickets as soon as tickets start to be sold.

In yet another example, if a temporary power outage or the like occurs in a particular region, it is assumed that requests are transmitted simultaneously from home electrical appliances such as refrigerators that are connected to a network and communicate with an application server to the application server immediately after a recovery from the power outage. In this case, requests to start a session used to perform communication with a home electric appliance are immediately processed and many sessions are established. After the sessions are established, however, many requests each of which involves a certain amount of processing load are transmitted in succession from home electric appliances to the server.

If, in a state in which sessions have been established with many client apparatuses, the application server receives many requests at one moment from client apparatuses, the application server may not process all requests that the application server has received. When this happens, it is assumed that the application server fails to process many received requests and many requests waiting to be executed are invalidated (or discarded) due to a session time-out.

A possible solution to this situation is to prolong the time-out time determined for the session according to the load on the server. However, it is not easy to determine an appropriate time-out time. If a long time-out time is set, the detection of an error caused by a device failure is delayed. Therefore, in a case in which, for example, the server receives many requests in one moment, it is desirable to suppress a session from timing out due to an insufficient throughput of the server.

In one aspect, an object of the present disclosure is to suppress a session that has caused a session time-out from being discarded if the session time-out is due to the insufficient throughput of the server. Embodiments will be described below with reference to the drawings.

### First embodiment

System Structure

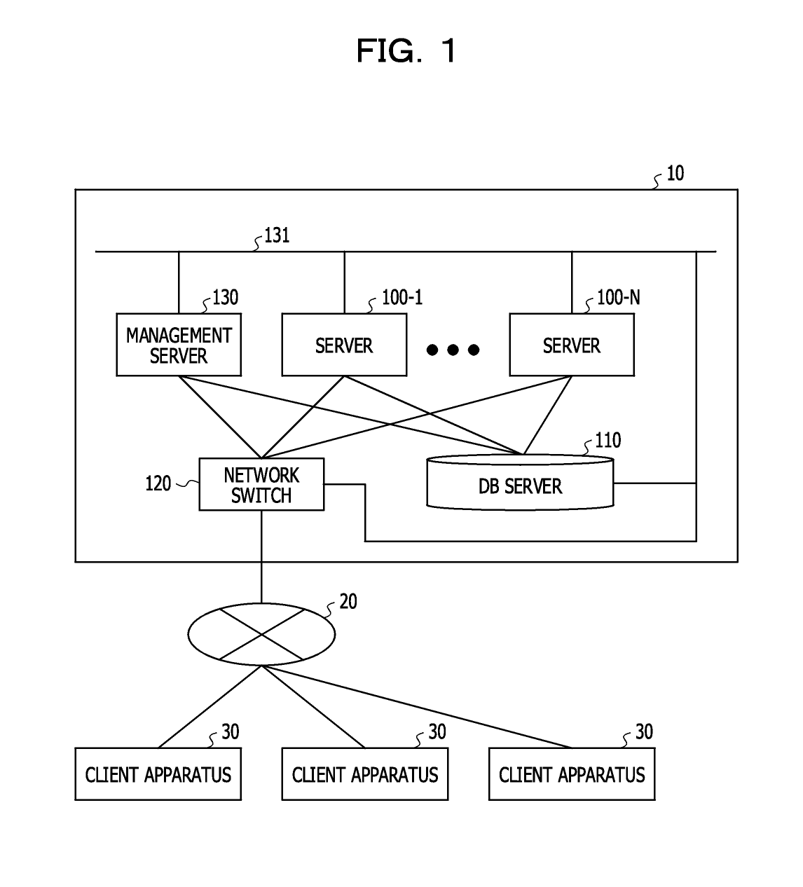

FIG. 1 illustrates an example of the system structure of an information processing system 10 in a first embodiment. As illustrated in FIG. 1, the information processing system 10 in this embodiment has N servers 100-1 to 100-N (N is a natural number), a database (DB) server 110, a network switch 120, and a management server 130. The information processing system 10 is connected to client apparatuses 30 through a network 20, which is external communication network such as the Internet. Each client apparatus 30 is not limited to a terminal apparatus that receives an operation by the user and requests a server to perform processing accordingly; the client apparatus 30 may be any of various electronic devices connected to a network. Examples of electronic devices connected to a network include network home appliances such as refrigerators that notify a server of the appliance's state through the Internet, television sets with communication functions, electronic meters and gas meters installed in office buildings and households, and sensor devices such as temperature sensors.

The information processing system 10 performs processing in response to, for example, a request received from the user through a client apparatus 30. After the information processing system 10 has performed processing demanded by the request received from the client apparatus 30, the information processing system 10 transmits the result of the processing to the client apparatus 30 as a replay.

Each of the servers 100-1 to 100-N is a server apparatus that executes application programs that perform various processing in response to requests transmitted from client apparatuses 30. The servers 100-1 to 100-N will be described below as the servers 100 if it is desirable not to distinguish them. Although, in the example in FIG. 1, N servers 100 denoted 100-1 to 100-N are provided, a plurality of servers 100 may not be provided; a single server 100 suffices.

The DB server 110 is a database apparatus that stores data related to processing performed by the servers 100. Specifically, the DB server 110 stores data and the like used by the operating system (OS) and applications executed in each server 100. The DB server 110 is implemented by a storage apparatus, a server having a large-capacity storage device, or the like.

The network switch 120, which is connected to the network 20, transfers communication packets present between servers 100 or the management server 130 and apparatuses connected to the network 20 to an appropriate destination apparatus. The management server 130 communicates with the servers 100-1 to 100-N, DB server 110, network switch 120, and the like disposed in the information processing system 10 through a local bus 131, which is a communication line in the information processing system 10, to manage these apparatuses.

Hardware Structure

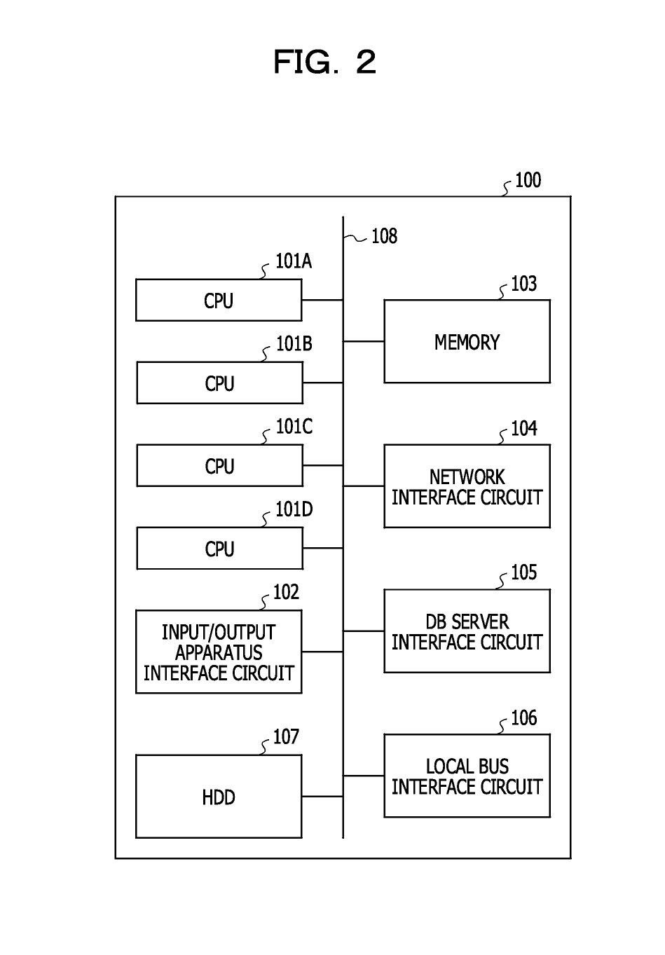

FIG. 2 illustrates an example of the hardware structure of the server 100. The server 100 has central processing units (CPUs) 101 (101A to 101D), an input/output apparatus interface circuit 102, a memory 103, a network interface circuit 104, a DB server interface circuit 105, a local bus interface circuit 106, and a hard disk drive (HDD) 107. Each CPU 101 accesses the memory 103, input/output apparatus interface circuit 102, and other interface circuits (104 to 106) through an internal bus 108.

The CPUs 101 (101A to 101D) are hardware resources of processors that perform various processing in the server 100. The CPUs 101 are each an electronic component included in the server 100. Although, in the example in FIG. 2, the server 100 has four CPUs 101, which are the CPU 101A, CPU 101B, CPU 101C, and CPU 101D, the number of CPUs 101 is not limited to 4, the server 100 may have more CPUs 101. One type of CPU has a plurality of CPU cores and hardware threads. A single CPU of this type can concurrently perform processes of a plurality of application programs. This type of CPU may be used as the CPU 101. In addition, the number of CPUs 101 mounted in one server 100 may vary depending on the server 100.

The input/output apparatus interface circuit 102 is a circuit that controls inputs and outputs from and to peripheral devices, such as a mouse and a keyboard, connected to the server 100. The memory 103 is a storage device such as a random-access memory (RAM). Although, in the example in FIG. 2, only one memory 103 is illustrated, the memory 103 may include a plurality of RAMs. Alternatively, separate memories 103 (103-1 to 103-N) may be provided in correspondence to the CPUs 101-1 to 101-N.

The network interface circuit 104 is an interface circuit used to communication with other apparatuses through the network 20. In the example in FIG. 1, the network interface circuit 104 is connected to the network 20 through the network switch 120. The DB server interface circuit 105 is an interface circuit used to access the DB servers 110. The local bus interface circuit 106 is an interface circuit used to communicate with the management server 130, other servers 100, and the like included in the information processing system 10 through the local bus 131.

The HDD 107 is a storage device that stores programs executed by the CPUs 101 and data used in processing executed by the CPUs 101.

Programs and data used in processing by a Web server 140 and an application server 150, which will be described later, the processing being executed in the server 100, are stored in the memory 103, HDD 107, or DB server 110. The relevant CPU 101 reads out programs and data stored in the HDD 107 or the like and executes programs related to processing executed by the Web server 140, the application server 150, or the like.

The management server 130 may be implemented by the hardware structure illustrated in FIG. 2. In this case, only one CPU denoted 101A may be mounted instead of mounting four CPUs (101A to 101D) as illustrated in FIG. 2. Processing performed by the management server 130 to manage all apparatuses in the information processing system 10 is executed when the CPU 101A executes programs stored in the memory 103 in the management server 130.

Functional Block 1

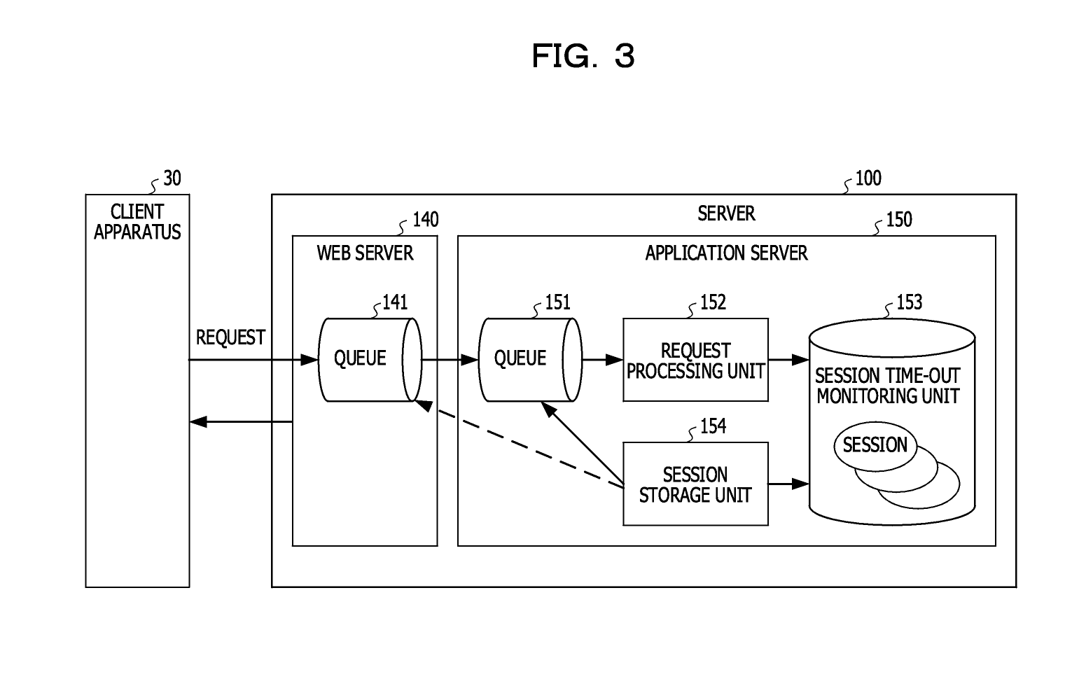

FIG. 3 illustrates an example of a functional block diagram of the information processing system 10 in the first embodiment. In FIG. 3, the server 100 includes the Web server 140 and application server 150. For convenience of explanation, only one client apparatus 30 is connected to the server 100 in FIG. 3. In practice, however, many client apparatuses 30 are connected to the server 100 through the network 20.

Processing by the Web server 140 and processing by the application server 150 are implemented when the CPUs 101 included in the server 100 execute predetermined programs. Both processing by the Web server 140 and processing by the application server 150 may be executed by a single CPU 101 or may be executed by different CPUs 101. Alternatively, processing by the Web server 140 may be executed by the server 100-1 included in the information processing system 10 and processing by the application server 150 may be executed by the other servers 100-2 to 100-N.

The server 100 processes a request received from the client apparatus 30 by using the Web server 140 and application server 150. Specifically, the Web server 140 receives a request from the client apparatus 30, after which the application server 150 executes processing demanded by the request received by the Web server 140 and passes an execution result to the Web server 140. The Web server 140 returns the execution result received from the application server 150 to the client apparatus 30.

The Web server 140 may be structured so as to have a queue 141. The queue 141 is a storage area in which a request received from the client apparatus 30 is temporarily stored until the request is transferred to the application server 150. The storage area used as the queue 141 is implemented by, for example, allocating part of the memory 103 as an area of the queue 141. If the application server 150 is ready for receiving a request received by the Web server 140, the Web server 140 may transfer a request received from the client apparatus 30 to the application server 150 without storing the request in the queue 141.

The application server 150 has a queue 151, a request processing unit 152, a session storage unit 153, and a session time-out monitoring unit 154. Processing by the request processing unit 152, session time-out monitoring unit 154, and the like is implemented when the CPUs101 that executes processing by the application server 150 execute predetermined programs stored in the memory 103, HDD 107, and the like.

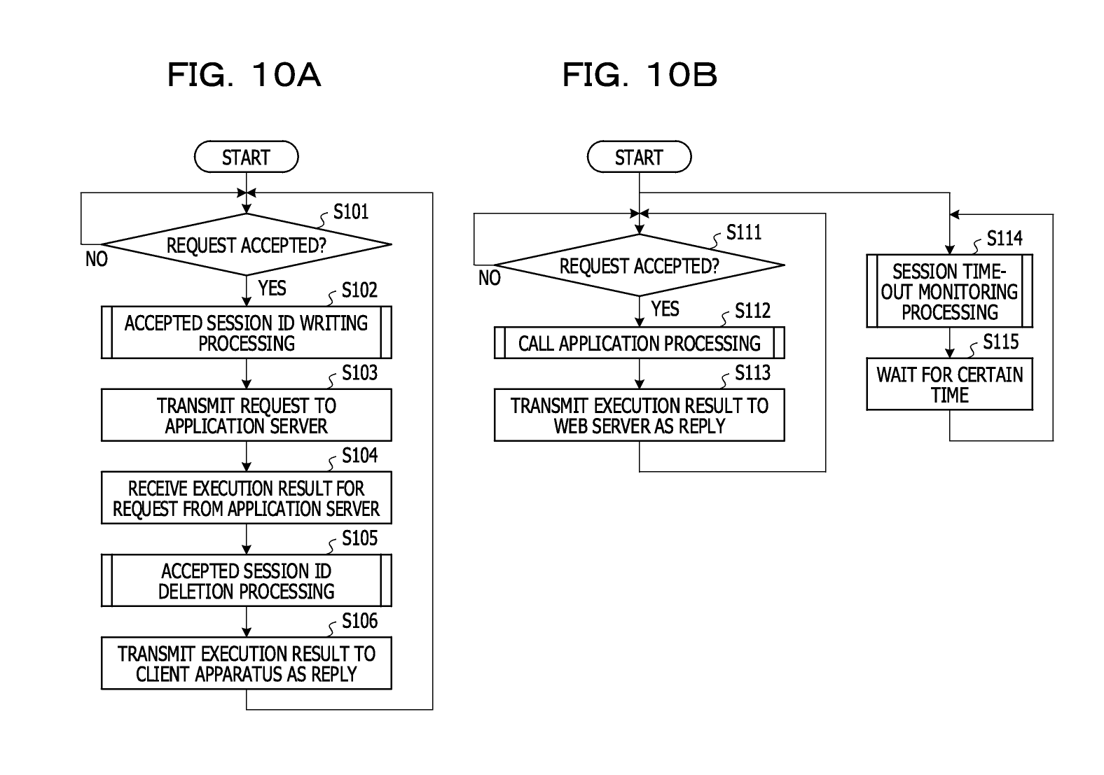

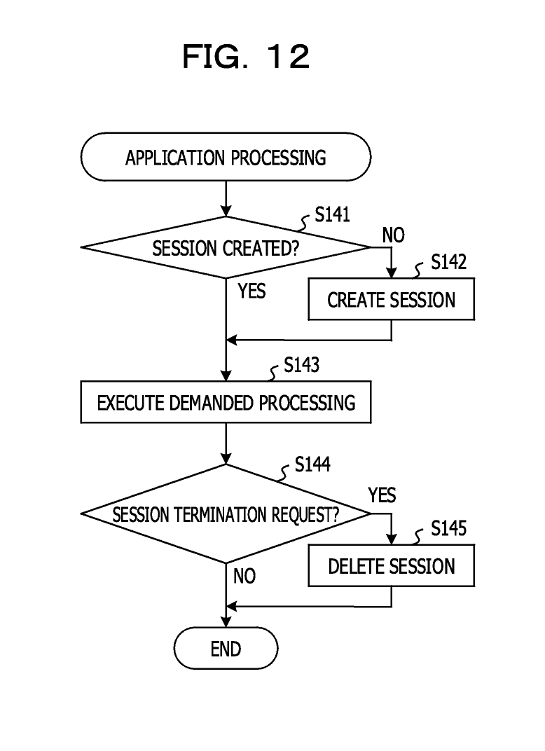

The request processing unit 152 executes processing demanded by a request received from the Web server 140. The request processing unit 152 also creates or deletes a session used in communication with the client apparatus 30 from which a request has been transmitted, updates information related to the session, and performs other processing. Processing by the request processing unit 152 is executed by a program that processes application processing called in response to a request received from the Web server 140. Application processing will be described later in detail with reference to FIGS. 10B and 12.

The queue 151 is a storage area in which a request received from the Web server 140 is temporarily stored until the request processing unit 152 becomes ready for processing the request. The storage area used as the queue 151 is implemented by, for example, allocating part of the memory 103 as an area of the queue 151. If, in the example of the functional block diagram in FIG. 3, an area large enough as a storage area of the queue 151 can be reserved, the queue 141, which would otherwise be included in the Web server 140, may not be allocated. Alternatively, a queue shared between the Web server 140 and the application server 150 may be allocated in a shared memory area in the memory 103.

The session storage unit 153 is an area allocated in part of the memory 103 or HDD 107 to store session-related information. Session-related information includes session identification information (session ID), application identification information (application ID), client apparatus identification information (client ID), and various setting information used in communication with client apparatuses 30 with which sessions have been established. Session identification information (session ID) is unique identification information assigned for each session established between one server 100 and the client apparatus 30. Application identification information (application ID) is unique identification information assigned for each application executed in the application server 150. Client apparatus identification information (client ID) is unique identification information assigned for each client apparatus 30.

The session time-out monitoring unit 154 performs session time-out monitoring processing on a periodic basis, in response to a request from the management server 130, or at another particular timing. In session time-out monitoring processing, the session time-out monitoring unit 154 monitors each session corresponding to session information stored in the session storage unit 153 as to whether a predetermined time-out time has elapsed. Processing by the session time-out monitoring unit 154 will be described later in detail.

Session Established Between a Client Apparatus 30 and a Server 100

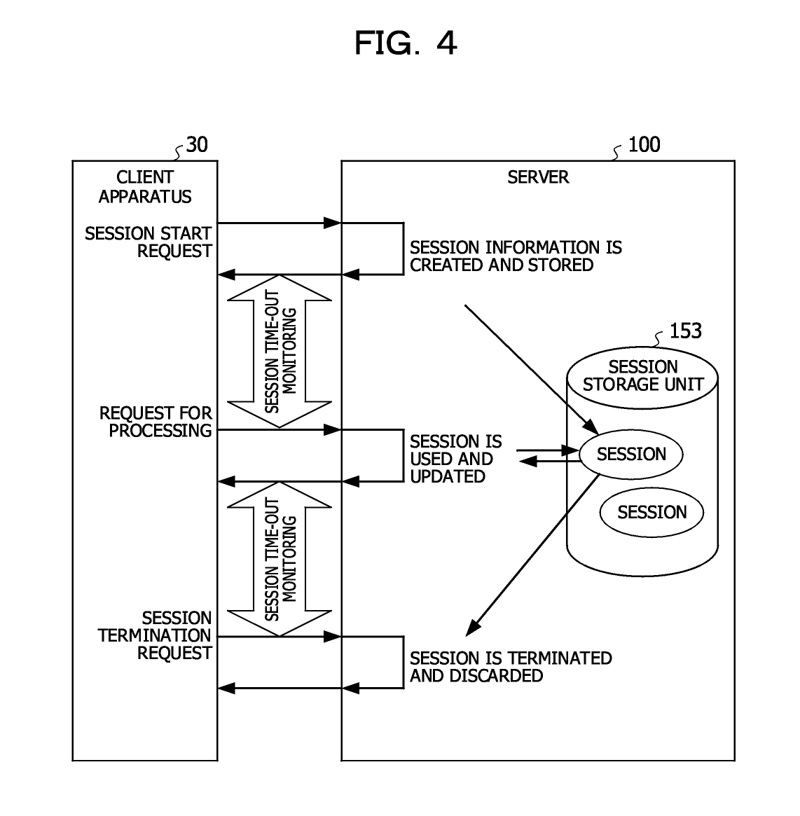

FIG. 4 illustrates a session established between a client apparatus 30 and a server 100. The client apparatus 30 communicates with the server 100 on a periodic basis or in response to an external input. To communicate with the server 100, the client apparatus 30 begins with transmitting a session start request to the server 100.

When the server 100 receives the session start request from the client apparatus 30, a handshake is performed between the client apparatus 30 and the server 100 according to a communication protocol and a session is established. In processing to establish the session, the server 100 creates session information related to the session demanded by the client apparatus 30 and stores the created session information in the session storage unit 153.

After the session has been established between the client apparatus 30 and the server 100, the server 100 transmits identification information about the session to the client apparatus 30. The client apparatus 30 transmits a request for processing of an application to the server 100 together with the identification information about the session.

Upon the reception of the request from the client apparatus 30, the server 100 updates information stored in the session storage unit 153 in relation to the session corresponding to the request and executes processing of an application in response to the request. A result of the executed processing is transmitted to the client apparatus 30 as a reply to the request.

The session established between the client apparatus 30 and the server 100 is terminated in response to a session termination request transmitted from the client apparatus 30. Upon the reception of the session termination request from the client apparatus 30, the server 100 deletes information about the relevant session from the session storage unit 153, and transmits, to the client apparatus 30, a reply indicating that the session termination processing has been completed.

A session established between the client apparatus 30 and the server 100 is terminated by a session time-out, besides a session termination request. After a session has been established between the server 100 and the client apparatus 30, the server 100 monitors a period during which processing demanded by the client apparatus 30 related to the session is not being executed.

In the example in FIG. 4, a period from when a session has started until processing demanded by the client apparatus 30 starts to be executed by the server 100 and a period after processing has been executed by the server 100 until a session termination request is processed are illustrated as session time-out monitoring periods. Session time-out monitoring periods are not limited to the periods illustrated in FIG. 4. A period after processing demanded by the client apparatus 30 has been executed by the server 100 until next demanded processing related to the same session starts to be executed is also a monitoring period.

In session time-out monitoring, it is monitored whether a period during which processing demanded by the client apparatus 30 with which the session has been established is not being executed has exceeded a predetermined time-out time. In this monitoring in this embodiment, besides the elapse of the time-out time, whether a request from the client apparatus 30 has arrived at the server 100 is also considered in the decision as to whether to invalidate (discard) the session due to a session time-out.

Session time-out decision processing in this embodiment will be described with reference to FIG. 3. The server 100 establishes sessions to communicate with many client apparatuses 30 and receives a request from each client apparatus 30. Therefore, information about sessions established with many client apparatuses 30 is stored in the session storage unit 153 in the server 100.

The session time-out monitoring unit 154 monitors whether the session corresponding to each information item stored in the session storage unit 153 has caused a session time-out, for example, on a periodic basis. Specifically, the session time-out monitoring unit 154 decides whether a period during which the server 100 has not been executing processing related to the target session, which is one of a plurality of sessions eligible for being monitored, has exceeded a time-out time predetermined for the target session.

In a conventional technology, a session for which the session time-out monitoring unit 154 detected a session time-out was forcibly invalidated or discarded. Along with the widespread use of the IoT technology, however, the server 100 may be involved in processing demanded by very many client apparatuses 30. In this situation, requests from client apparatuses 30 may concentrate at one moment. When this happens, requests that the application server 150 fails to process due to the physical insufficiency of the throughput of the server 100 are temporarily stored in the queue 151 or queue 141.

If a large number of requests waiting to be processed are already stored in the queue 151 or queue 141, in the conventional technology, many requests stored in the queue 151 or queue 141 have been discarded due to a session time-out, and a reply indicating a time-out error has been transmitted to the client apparatuses that had transmitted the discarded requests. Many client apparatuses that received the session-time out error reply try again, starting from a session start request. This operation not only increases the processing load on the server 100 but also causes network congestion. Therefore, it is desirable to suppress session time-outs due to the insufficient throughput of the server 100 as much as possible.

In this embodiment, in a session time-out decision, not only whether a time-out time has elapsed is decided but also whether a processing request has arrived from the client apparatus 30 corresponding to the session at the time of the session time-out decision is decided.

When the session time-out monitoring unit 154 makes a decision as to whether a session time-out has occurred, for example, on a periodic basis, the session time-out monitoring unit 154 extracts sessions for which a predetermined time-out time has elapsed. For each extracted session, the session time-out monitoring unit 154 decides whether a request related to the session is stored in the queue 151. It is possible to allocate a memory area to be reserved for the queue 141 in a memory area shared between the application server 150 and the Web server 140. In this case, the session time-out monitoring unit 154 can reference not only the queue 151 but also the queue 141, so the session time-out monitoring unit 154 determines that the request related to the session is stored in which queue, the queue 141 or queue 151. To simplify the description below, it will be assumed that the session time-out monitoring unit 154 can reference not only the queue 151 but also the queue 141.

Even if a session is extracted because the elapse of the time-out time has been decided, if a related request is stored in the queue 151 or queue 141, the session time-out monitoring unit 154 suppresses the session from being invalidated (or discarded) due to the session time-out. In a case in which a request intended to be executed is stored in the queue 151 or queue 141, the processing of the request is awaited due to the insufficient throughput of the server 100. Therefore, when a session related to a request is stored in the queue 151 or queue 141 to wait to be executed, even if the session causes a session time-out, the session time-out monitoring unit 154 does not invalidate (or discard) the session.

However, when a session is extracted because the elapse of the time-out time has been decided, but a related request is not stored in the queue 151 or queue 141, the session time-out monitoring unit 154 invalidates the session. The reason for this is to release the memory that would otherwise be continued to be reserved to manage the session without being used and to enable the memory to be used to manage another session.

### Effects of the First Embodiment

As described above, in the first embodiment, even if a session is decided to have caused a session time-out, if a request related to the session is stored in a queue to wait to be executed, the session decided to have caused a session time-out is not invalidated. Due to this type of control, it is possible to suppress a session that has caused a session time-out from being discarded if the session time-out is due to the insufficient throughput of the server 100.

### Second Embodiment

Functional Block 2

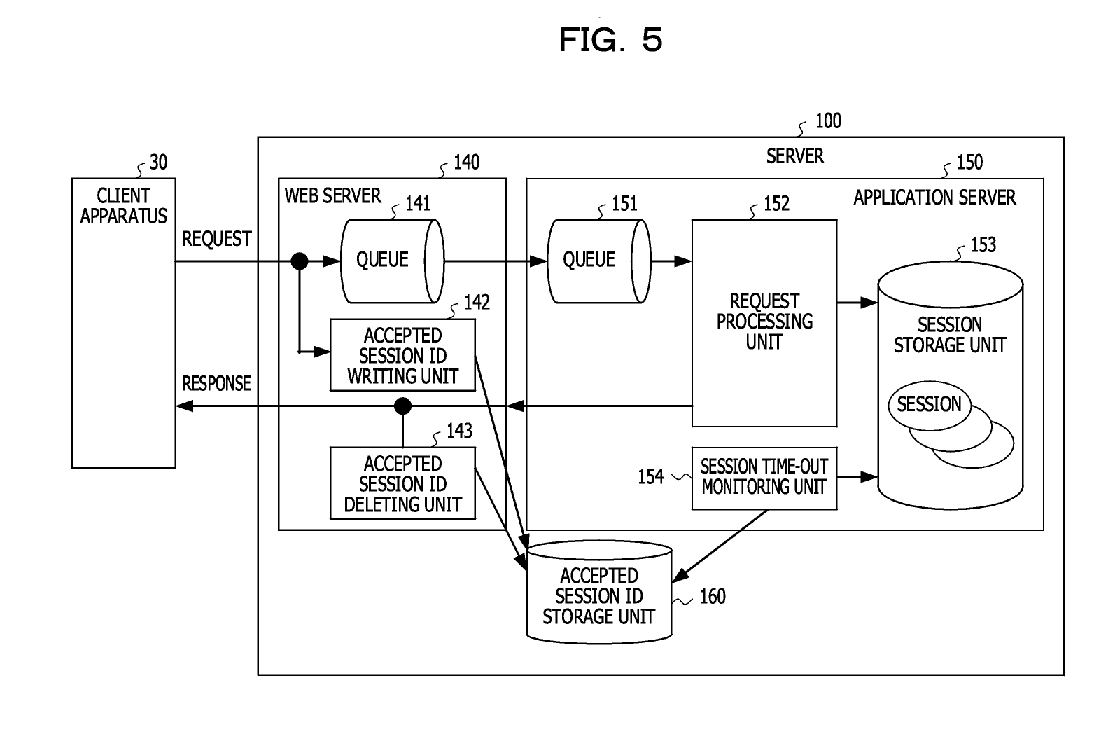

FIG. 5 illustrates an example of a functional block diagram of the server 100 in the second embodiment. In FIG. 5, the constituent elements assigned the same reference characters as in the functional block diagram in the first embodiment in FIG. 3 basically have the same function as the relevant constituent elements in the first embodiment.

In the second embodiment, an accepted session ID storage unit 160 is provided besides the functional block in the first embodiment in FIG. 3 so that whether a request related to a session that has caused a session time-out is stored in the queue 151 or queue 141 can be easily determined.

The accepted session ID storage unit 160 is a storage area in which each time the server 100 receives a request from the client apparatus 30, session identification information about the session corresponding to the received request is stored. The storage area of the accepted session ID storage unit 160 is reserved by, for example, allocating part of the memory 103. To adapt to the accepted session ID storage unit 160 provided in the server 100, an accepted session ID writing unit 142 and an accepted session ID deleting unit 143 are provided in the Web server 140.

Each time the Web server 140 receives a request from the client apparatus 30, the accepted session ID writing unit 142 stores identification information about the session corresponding to the received request in the accepted session ID storage unit 160. When an execution result of the processing corresponding to a request is transmitted to the client apparatus 30 as a reply, the accepted session ID deleting unit 143 deletes, from the accepted session ID storage unit 160, the session identification information corresponding to the request for which the execution result has been transmitted as a reply.

In making a decision as to whether a session time-out has occurred, the session time-out monitoring unit 154 in the second embodiment determines session identification information stored in the accepted session ID storage unit 160 instead of deciding whether a new request is stored in the queue 151 or queue 141. The session identification information stored in the accepted session ID storage unit 160 is held from when the request is received until processing demanded by the request is completed and an execution result is transmitted to the client apparatus 30 as a reply. That is, the corresponding session identification information is stored in the accepted session ID storage unit 160 not only for a period during which the request processing unit 152 is processing the received request but also for a period during which the request is stored in the queue 151 or queue 141 before the processing starts.

The second embodiment will now be compared with the first embodiment. The session time-out monitoring unit 154 in the first embodiment first extracts a session for which a session time-out has been detected and decides whether processing related to the session is being performed (first decision), after which the session time-out monitoring unit 154 decides whether the request corresponding to the extracted session is stored in the queue 151 or queue 141 (second decision). That is, in the first embodiment, two decisions have been further made for a session for which a session time-out had been detected.

In the second embodiment, however, it suffices for the session time-out monitoring unit 154 to decide only whether the session identification information corresponding to a session for which a session time-out has been detected is stored in the accepted session ID storage unit 160 at a time when the session time-out monitoring unit 154 performs processing to monitor a session time-out. In the second embodiment, therefore, by providing the accepted session ID storage unit 160, it is possible to easily perform control in which a request waiting to be executed is also considered in invalidating a session for which a session time-out has been detected.

Order in Which Requests are Processed

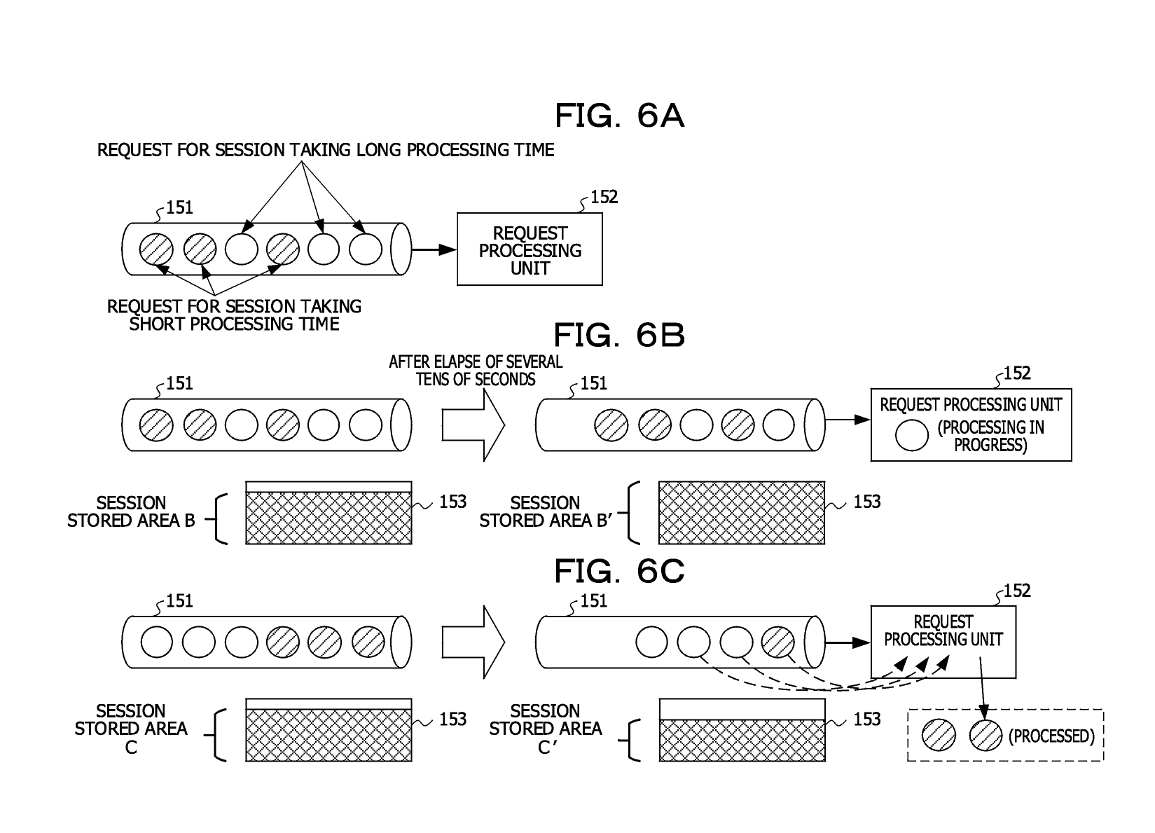

FIGS. 6A to 6C illustrate examples of a relationship between an order in which queued requests are processed and a session storage area. In FIGS. 6A to 6C, only constituent elements used in explanation are illustrated.

FIG. 6A illustrates a state in which requests waiting to be executed by the request processing unit 152 are stored in the queue 151. In the example in FIG. 6A, each open circle indicates a request for a session that takes a long processing time and each hatched circle indicates a request for a session that takes a short processing time. A request for a session that takes a long processing time is a request for which it is assumed that a long time will be taken to terminate the requested session, such as, for example, a request to start a new session. A request for a session that takes a short processing time is a request for which it is expected that processing of the request related to the session will be soon terminated.

FIG. 6B illustrates an example in which the request processing unit 152 processes requests in the order in which they were stored in the queue 151. The left side of the arrow at the center in FIG. 6B indicates a state before the requests are processed, and the right side indicates a state in which after the elapse of several tens of seconds, one request indicated by an open circle is being processed. Below the queue 151 in FIG. 6B, a change in the state of the storage area in the session storage unit 153 before and after the elapse of several tens of seconds is also indicated.

For convenience of explanation, it will be assumed that on the left side in FIG. 6B, an area (white portion) in which information related to one new session can be stored is left in the storage area in the session storage unit 153 besides a session stored area B. After several tens of seconds has elapsed in this state, one request at the beginning of the queue 151, which it the oldest received request, starts to be processed. A state in which the processing of the oldest request is in progress is indicated on the right side in FIG. 6B. Since a new session has been created, the storage area in the session storage unit 153 is filled with a session stored area B′, leaving no free space in the storage area in the session storage unit 153. Therefore, subsequent requests to start a new session fail to be executed, so the requests stored in the queue 151 continue to wait to be processed until information about sessions for which related processing is completed is deleted from the session stored area B′.

FIG. 6C illustrates an example in which the requests stored in the queue 151 in FIG. 6A are rearranged so that they are processed sequentially, starting from the request for the session that takes the shortest processing time. On the left side in FIG. 6C, the requests are rearranged so that session termination requests, for example, are placed at the first two positions in the queue 151. In this case, when the queue 151 enters the state on the right side in FIG. 6C after the elapse of several tens of seconds, this indicates that processing of the two session termination requests at the beginning has been completed. Therefore, it is found that a free area (white portion) larger than the free area on the left side in FIG. 6C has been reserved in the storage area in the session storage unit 153, besides a session storage area C′. Accordingly, it is possible to have the request processing unit 152 process requests up to the second open-circle request stored in the queue 151, that is, three contiguous requests from the beginning of the queue 151 in succession.

If requests that are stored in the queue 151 and are waiting to be executed can be rearranged, when the order in which the requests are executed is changed, more requests can be processed. That is, the throughput of the application server 150 can be improved in a situation in which many requests waiting to be executed stay in the queue 151.

However, requests are classified into types. The order of some requests preferably remains unchanged, and the order of other requests may be changed. Examples of requests the order of which preferably remains unchanged include requests for which entered information and processing are preferably processed sequentially as in a case in which persons use client apparatuses 30 to reserve tickets. Some requests transmitted from electronic devices are preferably processed sequentially. For these requests for which their order is preferably assured, it is desirable not to execute a request at a later position in the order before a request at an earlier position is executed.

Examples of requests the order of which may be changed include requests that transmit a status report by which a client apparatus 30 such as a home electrical appliance connected to the network 20 periodically notifies a server 100 of the state of the home electrical appliance. When requests or the like transmit a status report transmitted from a home electrical appliance or the like, the order in which these requests are executed may be changed. Processing of these requests is often terminated in a shorter time than in processing based on operations by a person.

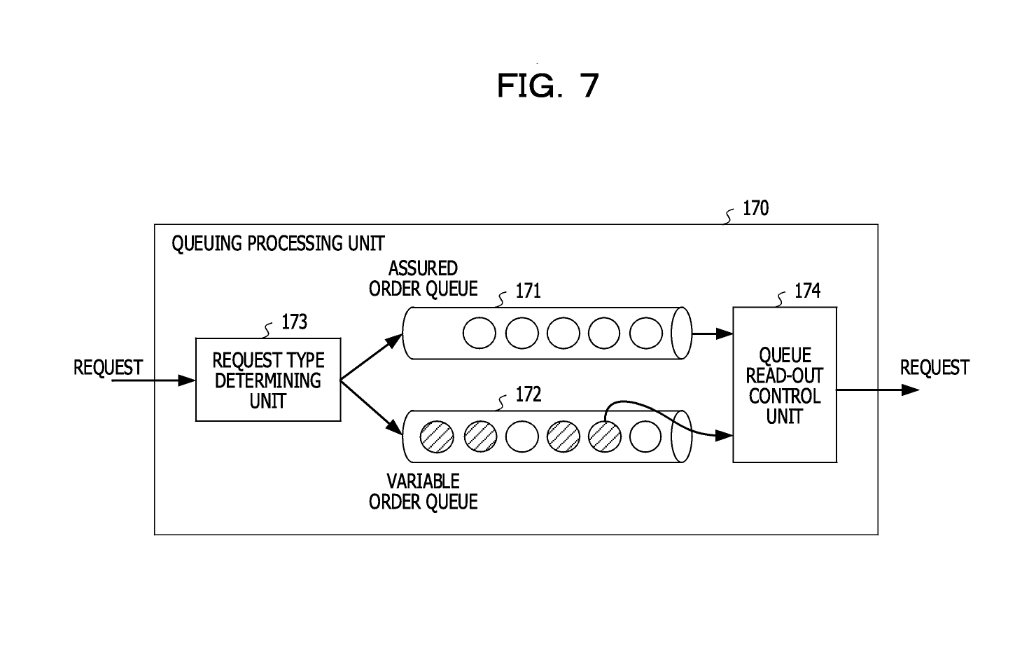

As described above, the order of some requests may be changed, and the order of other requests preferably remains unchanged. Processing may take a long time or a short time, depending on the request. Therefore, it is desirable to determine the type of requests and, if the order of these requests may be changed, change their order according to the processing time taken by each request. An example of a queuing processing unit 170 that controls the changing of the order of requests will be described below with reference to FIG. 7.

FIG. 7 illustrates an example of the queuing processing unit 170 in the second embodiment. The queuing processing unit 170 is an example of a specific embodiment of the queue 151 or queue 141 illustrated in FIGS. 3 and 5. The queuing processing unit 170 has an assured order queue 171, a variable order queue 172, a request type determining unit 173, and a queue read-out control unit 174.

The assured order queue 171 is a queue in which requests the execution order of which preferably remains unchanged are temporarily stored. The variable order queue 172 is a queue in which requests the execution order of which may be changed are temporarily stored. The request type determining unit 173 determines the type of a received request and determines a queue, assured order queue 171 or variable order queue 172, in which to store the received request. The queue read-out control unit 174 reads out requests from both the assured order queue 171 and the variable order queue 172 and outputs the read-out requests in a predetermined method.

In the example in FIG. 7, since each request is selectively stored in the assured order queue 171 or variable order queue 172, whichever is appropriate, it is possible to easily control the order of queued requests. Specifically, the order of requests stored in the assured order queue 171 can be easily assured by retrieving them in the order in which these requests were stored. An order in which requests stored in the variable order queue 172 are read out can be determined under a predetermined condition as described later, independently of the order in which these requests were received.

Each of the number of assured order queues 171 and the number of variable order queues 172 is not limited to 1. A plurality of assured order queues 171 may be provided, and a plurality of variable order queues 172 may be provided. For example, a plurality of assured order queues 171 to which different priority orders are assigned may be provided. Similarly, a plurality of variable order queues 172 to which different priority orders are assigned may be provided. Alternatively, a plurality of assured order queues 171, a plurality of variable order queues 172, or both may be provided according to the type of processing demanded by requests to be stored or to the type of the application.

The queuing processing unit 170 may be implemented in the queue 141 in the Web server 140. In particular, if, for example, a plurality of servers 100 that execute application processing are used, the queuing processing unit 170 may be implemented in the queue 141 in the Web server 140 and as many assured order queues 171 and variable order queues 172 as there are servers 100 may be provided.

Even if requests are of a type in which it is desirable to assure their order, when these requests have been transmitted from different client apparatuses 30 or will be processed by different applications, their order may not often be assured. Therefore, if a plurality of assured order queues 171 are provided, it is possible to concurrently handle a plurality of groups of requests the order of which is preferably assured.

The request type determining unit 173 decides whether a received request is of a type in which the execution order may be changed or preferably remains unchanged, according to the type of processing demanded by the received request. For convenience, a request of a type in which the execution order may be changed will be referred to as a variable order request and a request of a type in which the execution order is preferably remains unchanged will be referred to as an assured order request. As a method of determining the type of a request, any one of the methods described below or a combination of these methods can be used.

(1) Determination Method Based on the type of Processing Demanded by a Request

If the type of processing demanded by a received request is to start or terminate a session, the request execution order may not be assured, so the received request is determined as a variable order request.

If it is already known that processing demanded by received requests includes processing in which an order may not be assured, the type of a request can be determined by holding the types of requests the order of which is preferably assured as a table in advance and comparing the request with the table. Information in a request may include, for example, a uniform resource locator (URL) ending with a description of an operation (such as, for example, http://xxx/yyy/zzz/operation1). In this case, the type of the demanded processing can be determined by checking operatoinl at the end of the URL, and whether to assure the order can be determined according to the type of the processing.

(2) Determination Method Based on the Type of an Application that Executes a Request

There is a case in which whether a request is of a type in which an order is preferably assured or may not be assured can be determined according to the type of an application that executes the request. If, for example, a request demands processing executed by an application that provides a service such as ticket reservation, the request can be predicted to be a request of a type in which an order is preferably assured. For a request processed by an application that collects votes in a hit television program, it suffices only to collect data. Therefore, the request can be predicted to be a request of a type in which an order may not be assured. Thus, whether a request is of a type in which an order is preferably assured or may not be assured can be determined according to the application that processes the request.

(3) Determination Method Based on the Type of a Client Apparatus 30 that has Transmitted a Request

There is a case in which whether a received request is a variable order request can be determined according to the type of a client apparatus 30 that has transmitted the request. A client apparatus 30 that has transmitted a request may be, for example, an apparatus that periodically transmits data acquired by a sensor to a server 100. In this case, an order in which data is received does not affect processing by an application that collects data used in execution in the server 100. Therefore, the received request can be determined to be a variable order request from the type of the client apparatus 30 that has transmitted the request or specific identification information. As information used to identify a client apparatus 30, the Internet protocol (IP) address of the client apparatus 30 or another type of identification information, for example, may be used. If information indicating the attribute of the client apparatus 30 is included in the request, the attribute information may be used to identify the client apparatus 30.

(4) Determination Method Based on Control Information Included in a Request

Information in some requests may include control information that indicates whether to assure an order. In this case, whether to assure an order for the received request can be determined from the control information included in the request.

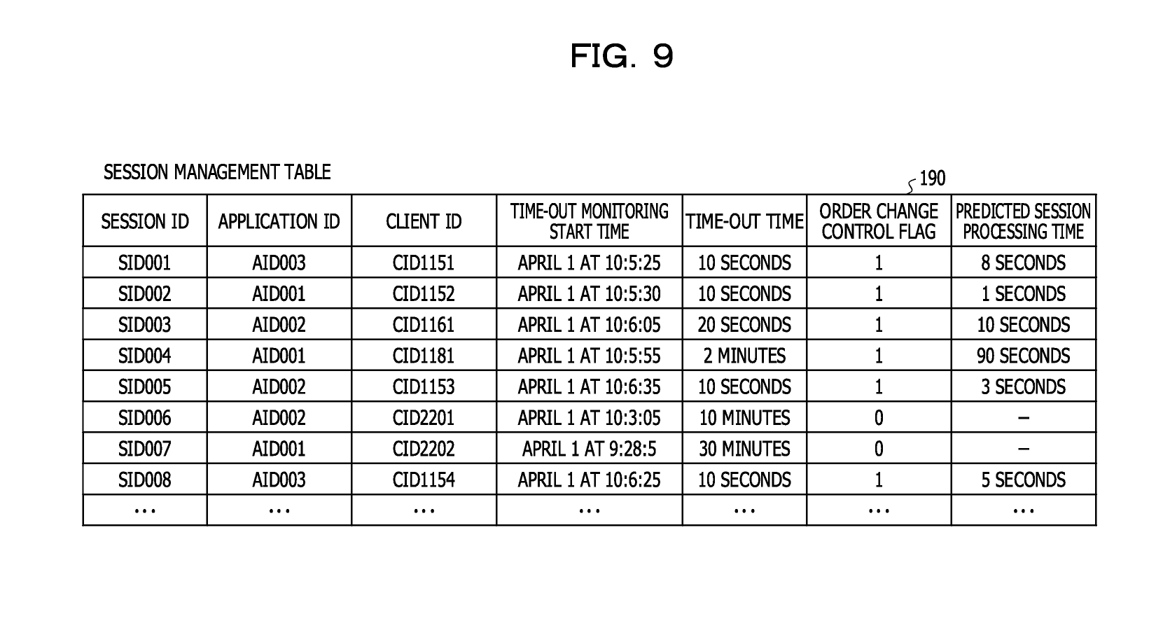

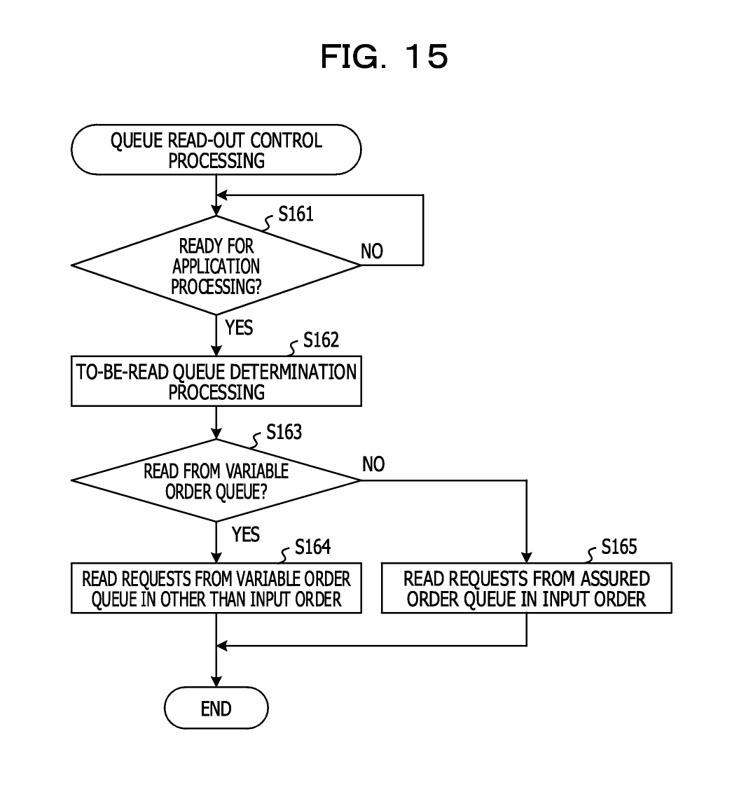

The queue read-out control unit 174 reads out requests from the assured order queue 171 in the order in which the requests were input. The queue read-out control unit 174 also reads out requests from the variable order queue 172 in the order determined according to a predetermined condition. Processing by the queue read-out control unit 174 will be described later in detail with reference to FIGS. 9 and 15.

Setting a session time-out value suitable to the type of a client apparatus 30

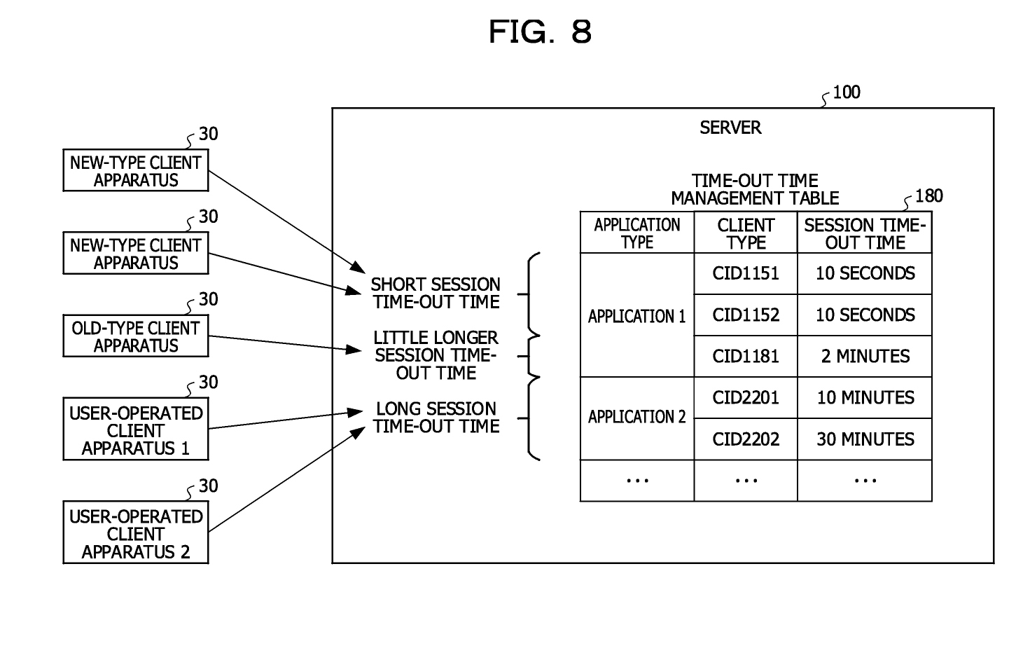

FIG. 8 illustrates how to set a session time-out value suitable to the type of a client apparatus 30.

In a conventional application server, a session time-out value has been set according to the type of an application. For, for example, a ticket selling application, an in-house attendance management application, and other applications that perform processing in response to an operation by a person, a different time-out time such as 20 minutes or 1 hour has been set according to the type of processing executed by a different application.

Along the widespread use of the IoT technology, however, various client apparatuses communicate with application servers. In this situation, various types of client apparatuses may transmit requests to one application. For example, a request based on information input by a person and a request based on processing performed by an electronic device may be transmitted to the same application. In this case, it is desirable to set a long time-out time for an operation by the person so that a session time-out does not occur during the operation. By contrast, even if a short time-out time is set for an article (machine) such as an electronic device, this is not a problem because processing is mechanically performed in response to a request. Rather, since errors in electronic devices and the like are often attributable to device failures, network breakages, and other factors, short session time-out values are desirable to find errors as early as possible.

Even if client apparatuses are of the same type, a low-performance client apparatus manufactured 10 years ago and the latest client apparatus perform processing at largely different speeds. Therefore, even if devices that transmit a request are of the same type, it may be desirable to set, for each device that transmits a request, a session time-out time to an appropriate time depending on the model number of the device.

In view of this situation, in this embodiment, a session time-out time suitable to the session is set in consideration of not only the type of an application that processes the request but also the type of the client apparatus 30 that transmitted the request. A time-out time management table 180 is an example of a session time-out time management table in which different session time-out times are set for different types of applications and different types of client apparatuses 30.

When an appropriate session time-out time is set for each session according to the type of an application and the type of a client apparatus 30, it becomes possible to cause a time-out at an earlier stage to release a session storage area related to a session placed in a state in which processing is not executed.

In the example in FIG. 8, the client apparatus 30 corresponding to client identification information starting with CID11 is an electronic device such as an Internet home appliance, and the client apparatus 30 corresponding to client identification information starting with CID22 is a terminal apparatus operated by a user.

In the example illustrated in the time-out time management table 180, a time-out time of 10 seconds is set for new-type client apparatuses (client identification information is CID1151 or CID1152), which transmit a request to application 1, and a time-out time of 2 minutes is set for an old-type client apparatus (client identification information is CID1181), which also transmits a request to application 1. A time-out time of 10 minutes is set for user-operated client apparatus 1 (client identification information is CID2201), which transmits a request to application 2, and a time-out time of 30 minutes is set for user-operated client apparatus 2 (client identification information is CID2202), which also transmits a request to application 2.

When different session time-out times are set according to both the types of applications and the types of client apparatuses, it is desirable to manage these session time-out times for each session. In this embodiment, therefore, a session management table 190 as illustrated in FIG. 9 is used to appropriately manage each of a plurality of sessions established with many client apparatuses.

Although an example in which different session time-out times are set according to both the types of applications and the types of client apparatuses has been described above, session time-out times may be set according to only the types of client apparatuses. An aspect in which session time-out times are set according to only the types of applications is also included in this embodiment.

Session Management Table

FIG. 9 illustrates an example of a session management table 190. The session management table 190 may be stored in the storage area in the session storage unit 153 together with information about each session or may be stored in an area allocated in the memory 103 separately from the session storage unit 153. The session management table 190 includes session IDs, application IDs, client IDs, information about a time-out monitoring start time for each session, session time-out times, order change control flags, and predicted session processing times.

The session ID is identification information used to identify a session. The same information as this identification information is set in the accepted session ID storage unit 160 as well, in relation to the relevant request. The application ID is identification information about an application that performs processing demanded by a request. The client ID is identification information about a client apparatus that transmits a request. A naming rule can be applied to client IDs so that, for example, if the client ID starts with CID11xx (x is an arbitrary character), the client ID indicates that the client apparatus is an electronic device and that if the client ID starts with CID22xx, the client ID indicates that the client apparatus is a user terminal. When this type of naming rule is applied, the type of a client apparatus can be easily identified, enabling a session time-out time and the like to be easily set. The session time-out times in FIG. 9 have been set for a plurality of sessions.

If the value of the order change control flag is 1, it indicates that the execution order of requests related to the session may be changed. If the value of the order change control flag is 0, it indicates that it is difficult to change the execution order of requests related to the session.

The predicted session processing time indicates a predicted processing time taken to complete processing in the session. The predicted session processing time can be set according to, for example, a history of execution times in previous sessions having a combination of the same application ID and client ID as in the current session or the type of processing included in the request related to the session.

Specifically, if a URL including an operation name (such as, for example, http://xxx/yyy/zzz/operation1) is included in a request, the predicted session processing time can be inferred from the number of times a request for the processing (operation1) was transmitted, a time interval at which requests were transmitted, and other information. A time interval at which requests were transmitted may be inferred from, for example, a difference between time-out monitoring start times for a request that was transmitted a plurality of times for the same session. Alternatively, since the processing time varies with the type of processing demanded by a request, the predicted session processing time may be inferred by comparing processing time taken in the processing (operation-x) included in the request with processing time taken when the same processing was performed in the past. If the request is, for example, a session termination request, it is also possible to set the predicted session processing time to the shortest time such as, for example, 0.01 second or 0 second.

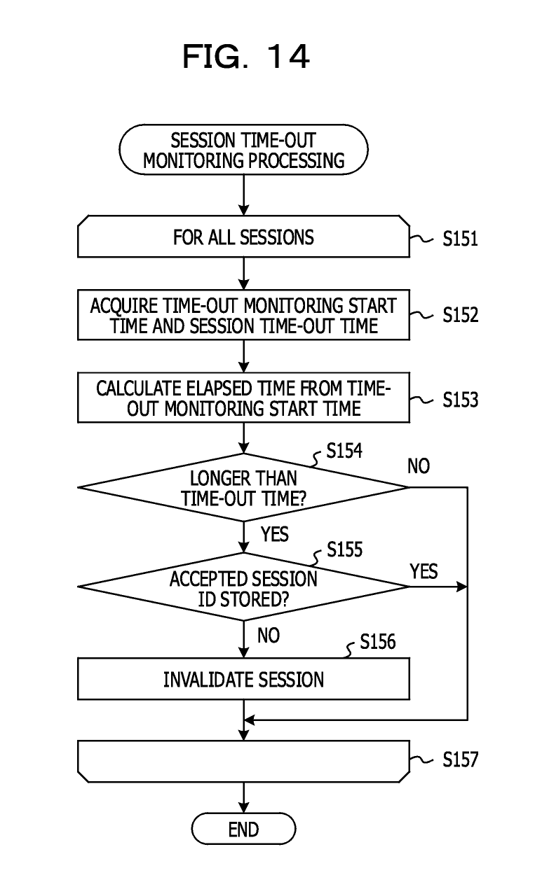

Of the information recorded in the session management table 190, the session ID, time-out monitoring start time, and time-out time are used in session time-out monitoring processing that is periodically performed by the session time-out monitoring unit 154. The session ID, order change control flag, and predicted session processing time are used in queued request read-out control performed by the queue read-out control unit 174. Session time-out monitoring processing and queued request read-out control will be described later in detail with reference to FIGS. 14 and 15, respectively.

Flowcharts

Next, a method in which the server 100 processes information will be described with reference to FIGS. 10A and 1013. FIG. 10A is a flowchart illustrating an example of processing by the Web server 140, and FIG. 1013 is a flowchart illustrating an example of processing by the application server 150.

Whether the Web server 140 has received a request from a client apparatus 30 is decided in S101. If the Web server 140 has not received a request from the client apparatus 30 (the result in S101 is No), the Web server 140 continues to wait until it receives a request from the client apparatus 30. If the Web server 140 has received a request from the client apparatus 30 (the result in S101 is Yes), the Web server 140 performs accepted session ID writing processing (S102).

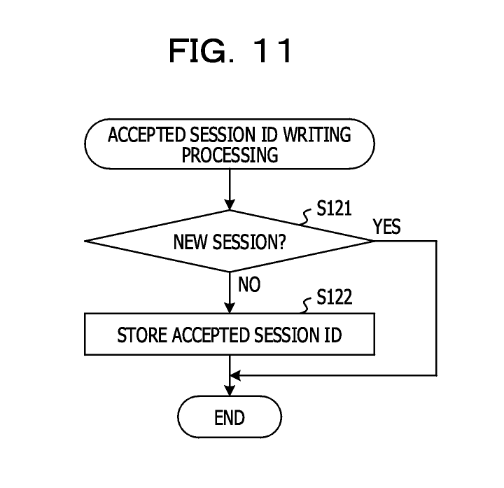

FIG. 11 is a flowchart illustrating an example of accepted session ID writing processing (S102) in FIG. 10A. When the Web server 140 receives a request from the client apparatus 30, the accepted session ID writing unit 142 decides whether the session corresponding to the received request is a new session (S121). Specifically, if session information is not included in the received request, the accepted session ID writing unit 142 decides that the session corresponding to the received request is a new session. In a case as well in which the received request is a session start request, the accepted session ID writing unit 142 decides that the session corresponding to the received request is a new session.

If the session corresponding to the received request is a new session (the result in S121 is Yes), indicating that there is no identification information corresponding to the request, the accepted session ID writing unit 142 terminates the accepted session ID writing processing. If the session corresponding to the received request is not a new session (the result in S121 is No), the accepted session ID writing unit 142 stores, in the accepted session ID storage unit 160, session identification information included in the request, in correlation with the request (S122) and terminates accepted session ID writing processing. Upon the completion of the accepted session ID writing processing in S102 in FIG. 1013, the Web server 140 transmits the received request to the application server 150 (S103).

Whether the application server 150 has received a request from the Web server 140 is decided in S111. If the application server 150 has not received a request from the Web server 140 (the result in S111 is No), the application server 150 continues to wait until it receives a request from the Web server 140. If the application server 150 has received a request from the Web server 140 (the result in S111 is Yes), the application server 150 calls application processing (S112).

FIG. 12 is a flowchart illustrating an example of application processing (S112) in FIG. 1013. If the request processing unit 152 in the application server 150 receives a request from the Web server 140, the request processing unit 152 decides whether a session has been created in correspondence to the received request (S141). Specifically, if there is no session identification information corresponding to the received request or the request is a session start request, the request processing unit 152 decides that a session has not been created in correspondence to the received request (the result in S141 is No). If a session has not been created (the result in S141 is No), the request processing unit 152 creates a session in correspondence to the received request (S142) and stores information related to the created session in the session storage unit 153 and session management table 190.

If a session has been created in correspondence to the received request (the result in S141 is Yes) or is created in S142, the request processing unit 152 executes processing demanded by the request (S143). Processing demanded by the request includes not only application processing demanded by the client apparatus 30 but also processing related to a session start request and a session termination request.

If the request is a session termination request (the result in S144 is Yes), the request processing unit 152 deletes information about the corresponding session from the session storage unit 153 and session management table 190 (S145). If the request is not a session termination request (the result in S144 is No), the processing in FIG. 12 is terminated. When information about the corresponding session is to be deleted in S145, part of the information may be stored, as history information, in a storage area used to record historical information. This is because the history information is used later to predict the predicted session processing time in the session management table 190.

Upon the termination of the application processing in FIG. 12, the application server 150 transmits an execution result in the application processing to the Web server 140 as a reply (S113 in FIG. 1013.). When the Web server 140 receives the execution result for the request from the application server 150 (S104), the Web server 140 performs accepted session ID deletion processing (S105).

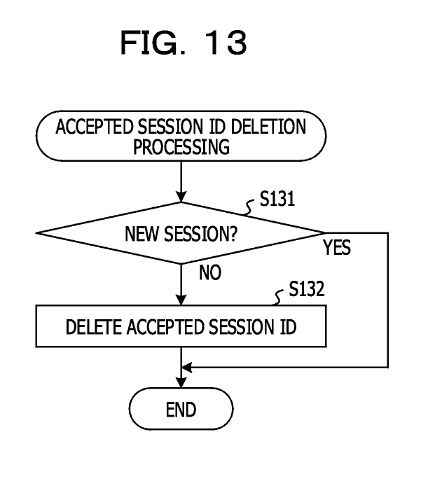

FIG. 13 is a flowchart illustrating an example of accepted session ID deletion processing (S105), in FIG. 10A, which is executed by the accepted session ID deleting unit 143. If the request processed by the application server 150 is a new request (the result in S131 is Yes), indicating that session identification information is not stored in the accepted session ID storage unit 160 in correspondence to the request, the processing is terminated. If the request processed by the application server 150 is not a new request (the result in S131 is No), the accepted session ID deleting unit 143 deletes the session identification information corresponding to the request from the accepted session ID storage unit 160 (S132) and terminates accepted session ID deletion processing.

Upon the completion of the accepted session ID deletion processing (S105), the Web server 140 transmits the execution result received from the application server 150 to the client apparatus 30 as a reply to the request (S106). Processing by the Web server 140 and processing by the application server 150 are performed for one request in this way. The application server 150 performs session time-out monitoring processing concurrently with processing related to the received request (S114).

FIG. 14 is a flowchart illustrating an example of session time-out monitoring processing (S114) in FIG. 1013. For all sessions corresponding to session information stored in the session storage unit 153, the session time-out monitoring unit 154 periodically decides whether a session time-out has occurred (loop in S151 to S157).

First, the session time-out monitoring unit 154 selects one of the sessions corresponding to session information stored in the session storage unit 153 (S151). The session time-out monitoring unit 154 then acquires information about the time-out monitoring start time corresponding to the selected session and information about a session time-out time from the session management table 190 (S152).

The session time-out monitoring unit 154 calculates an elapsed time from the current time and the time-out monitoring start time acquired in S152 (S153). If the calculated elapsed time is not longer than the session time-out time acquired in S152 (the result in S154 is No), indicating that a session time-out has not occurred, the session time-out monitoring unit 154 proceeds to processing in S157. If the calculated elapsed time is longer than the session time-out time acquired in S152 (the result in S154 is Yes), indicating that a session time-out has occurred, the session time-out monitoring unit 154 proceeds to processing in S155.

In S155, the session time-out monitoring unit 154 decides whether the session identification information corresponding to the session that has timed out is stored in the accepted session ID storage unit 160. If the corresponding session identification information is stored in the accepted session ID storage unit 160 (the result in S155 is Yes), indicating the request corresponding to the session has been already received, the session time-out monitoring unit 154 does not invalidate the session, which would otherwise be invalidated due to the session time-out, but proceeds to S157.

If, in S155, the session time-out monitoring unit 154 decides that the corresponding session identification information is not stored in the accepted session ID storage unit 160 (the result in S155 is No), the session time-out monitoring unit 154 performs processing to invalidate (discard) the session (S156). In processing in S156, the session time-out monitoring unit 154 deletes information about the session from the session storage unit 153, session management table 190, and accepted session ID storage unit 160.

In this embodiment, when the session time-out monitoring unit 154 monitors a time-out for each session, the session time-out monitoring unit 154 decides not only whether the session time-out time has been exceeded but also whether the corresponding session identification information is stored in the accepted session ID storage unit 160. Thus, even if the time-out time elapses during a session, if a related request has been already received or is being executed, it is possible to suppress the session from being invalidated (discarded) due to a session time-out.

If a decision has been made for all sessions as to a session time-out in S157, the session time-out monitoring unit 154 terminates the processing. If there is a session for which a decision has not yet been made as to a session time-out, the session time-out monitoring unit 154 returns to S151 to select a next session, after which the session time-out monitoring unit 154 performs processing in S152 to S156. Upon the completion of the session time-out monitoring processing in FIG. 14, the session time-out monitoring unit 154 proceeds to S115 in FIG. 1013 and waits until a certain time elapses, after which the session time-out monitoring unit 154 returns to S114 and periodically performs session time-out monitoring processing.

In processing in S114 and S115 in FIG. 10A and processing in FIG. 14, session time-out monitoring processing has been periodically performed by the session time-out monitoring unit 154. However, session time-out monitoring processing performed by the session time-out monitoring unit 154 is not limited to periodic monitoring processing; session time-out monitoring processing may be performed in response to a request from the management server 130 or at another particular timing.

FIG. 15 is a flowchart illustrating an example of queue read-out control processing. The queue read-out control unit 174 in the queuing processing unit 170 illustrated in FIG. 7 performs read-out processing to read out requests stored in the assured order queue 171 and variable order queue 172, as indicated in the flowchart in FIG. 15. As described above, the queuing processing unit 170 can be implemented in the queue 151 and queue 141 illustrated in FIGS. 3 and 5 as a specific embodiment. For convenience of explanation, however, a case in which the queuing processing unit 170 is implemented in the queue 151 in the application server 150 will be described below as an example.

The assured order queue 171 and variable order queue 172 hold requests until the request processing unit 152 in the application server 150 becomes ready for starting processing. Therefore, during a period in which the request processing unit 152 fails to process a next request (the result in S161 is No), the queue read-out control unit 174 waits without reading out requests from the assured order queue 171 and variable order queue 172. To make a decision as to whether the request processing unit 152 has become ready for processing a next request (S161), the queue read-out control unit 174 may monitor the execution state of the request processing unit 152 or may wait for a request from the request processing unit 152.

If the request processing unit 152 has become ready for processing a next request (the result in S161 is Yes), the queue read-out control unit 174 determines a queue from which to reads out a request (S162).

As a method in which the queue read-out control unit 174 determines a queue, the assured order queue 171 or variable order queue 172, from which to read out requests, any one of the methods described below or a combination of these methods, for example, can be used.

(1) Method in Which Requests are Read Out Alternately From the Two Queues

If only one assured order queue 171 and only one 172 are provided, when the queue read-out control unit 174 outputs requests to the request processing unit 152, the queue read-out control unit 174 can read out requests alternately from these queues. If a plurality of assured order queues 171 and a plurality of variable order queues 172 are provided, it is also possible to determine a queue from which to read out requests according to a rule in a round-robin method.

(2) Method in Which a Queue is Determined According to the Number of Requests Stored in Each Queue

A queue, assured order queue 171 or variable order queue 172, from which to read out requests may be determined according to the apportionment of the number of requests stored in the assured order queue 171 and that stored in the variable order queue 172. In a case as well in which a plurality of assured order queues 171 and a plurality of variable order queues 172 are provided, a queue from which to read out requests may be determined according to the apportionment of the number of requests stored in the plurality of assured order queues 171 and that stored in the plurality of variable order queues 172.

(3) Method in Which a Queue is Determined Depending on Whether Requests Made by a Person or Requests From Devices are Stored in the Queue

If processing of a request made by a person is delayed, the person is made to wait. A possible solution to this is to further provide, in each of the assured order queue 171 and variable order queue 172, a queue in which requests made by persons are stored and a queue in which requests received from devices (electronic devices that are not operated by persons) are stored and then read out requests preferentially from the queues in which requests made by persons are stored.

(4) Method in Which a Queue is Determined According to the Amount of Free Space Remaining in the Storage Area in the Session Storage Unit 153

If the amount of free space remaining in the storage area in the session storage unit 153 falls to or below a certain threshold, requests may be read out preferentially from the variable order queue 172. As a result, a request related to a session in which processing is completely soon can be processed quickly, and the amount of free space in a storage area in a memory in which session information is stored can be increased at an earlier stage.

In S163 in FIG. 15, it is decided whether the queue determined in to-be-read queue determination processing (S162) is the variable order queue 172. If it is decided in to-be-read queue determination processing (S162) that requests are to be read from the variable order queue 172 (the result in S163 is Yes), the queue read-out control unit 174 proceeds to processing in S164. In S164, the queue read-out control unit 174 reads requests from the variable order queue 172 in an order different from the order in which they were input to the variable order queue 172, and outputs the read-out requests to the request processing unit 152.

If it is decided in to-be-read queue determination processing (S162) that requests are not to be read from the variable order queue 172 but to be read from the assured order queue 171 (the result in S163 is No), the queue read-out control unit 174 proceeds to processing in S165. In S165, the queue read-out control unit 174 reads requests from the assured order queue 171 in the order in which they were stored in the assured order queue 171, and outputs the read-out requests to the request processing unit 152.

As a method of determining an order in which to read out requests from the variable order queue 172, other than the order in which they were input to the variable order queue 172, in S164, any one of the methods described below or a combination of these methods, for example, can be used.

(1) Method in Which Requests are Read Out Sequentially, Starting From the Request Corresponding to the Shortest Predicted Session Processing Time

To compare the predicted session processing times corresponding to requests stored in the variable order queue 172, the queue read-out control unit 174 reads out predicted session processing times from corresponding session items stored in the session management table 190. The queue read-out control unit 174 sorts the read-out predicted session processing times and reads out the requests sequentially from the variable order queue 172, starting from the request corresponding to the session with the shortest predicted session processing time.

(2) Method in Which Requests are Read Out Sequentially, Starting From the Request With the Highest Degree of Urgency

The degree of urgency of each received request may be determined according to the type of the request or the type of an application that executes demanded processing. If a request with a high degree of urgency is included, the order of requests may be controlled so that the request with a high degree of urgency is read out early. This is because when an order is controlled so that a request with a high degree of urgency is read out early, if a failure occurs, for example, the urgent request can be processed quickly and a reply can be transmitted.

As a method of indirectly determining a request with a high degree of urgency, an order may be controlled so that a request that is less frequently received, as determined from a previous history, is read out earlier. This is because a request that is less frequently generated is highly likely to be a request with a high degree of urgency.

As a control method when the queue read-out control unit 174 reads out requests from the variable order queue 172, any one of the methods described below or a combination of these methods, for example, can be used.

(1) Method in Which Positions in the Variable Order Queue 172 at Which Requests are Stored are Changed in Advance

Positions in the variable order queue 172 at which records are stored can be changed in advance before the queue read-out control unit 174 performs processing to read out requests from the variable order queue 172. Then, if reading from the variable order queue 172 is decided (the result in S163 is Yes), the queue read-out control unit 174 can simply read out requests sequentially, starting from the beginning of the variable order queue 172, so the queue read-out control unit 174 can read out a request of interest immediately.

(2) Method in Which an Order in Which Pointers Referenced in Read-Outs From the Variable Order Queue 172 are Placed is Determined in Advance

As another embodiment to read out requests from the variable order queue 172, read-out pointers (addresses at which requests are stored) from the variable order queue 172 may be sorted among the predicted processing times corresponding to requests and the sorted read-out pointers may be stored in a pointer table. Then, the queue read-out control unit 174 can use a pointer stored at the beginning of the pointer table to read out a request from the variable order queue 172.

(3) A Method in Which a Timing at Which to Control the Changing of Positions at Which Requests are Stored is Determined

Positions in the variable order queue 172 at which requests are stored may be changed at a timing when a request is stored in the variable order queue 172 or when a request is read out. This is because when the order of requests is changed at a timing when a request is stored in or read out from the variable order queue 172, requests can be read out in an appropriate order matching the latest request reception situation.

Alternatively, the order of requests may be changed at periodic timings. This is because when the order of requests is changed at periodic timings, a load on processing to determine a new order of requests can be reduced.

### Effects of the Second Embodiment

In the second embodiment, the accepted session ID storage unit 160 is provided. In session time-out monitoring processing, it is decided whether the identification information corresponding to a session for which a session time-out has been detected is stored in the accepted session ID storage unit 160. This makes it easier to control the invalidation of a session due to a session time-out in consideration of requests as well that are waiting to be executed.

The assured order queue 171 and variable order queue 172 are provided as queues in which requests are stored. By changing the order in which requests the order of which may not be assured are read, requests can be more efficiently processed. In addition, in the second embodiment, an appropriate session time-out time is set for each session according to the type of the application and the type of the client apparatus 30. Thus, it becomes possible to release a session storage area related to a session placed in a state in which processing is not executed, at an earlier stage by causing a time-out.

So far, preferred embodiments of the present disclosure have been described, but the present disclosure is not limited to particular embodiments. Various modifications and changes as described below are possible.

(1) Distribution Processing by Use of a Plurality of Servers 100

It is also possible to use application servers 150 executed in hardware in a plurality of servers 100 to process requests accepted by a single Web server 140 in a distributed manner. In this case, control is possible so that the number of servers 100 to be used is dynamically changed according to the number of received requests and power to servers 100 that are not in use is stopped. Due to this control, the system's throughput enough to process requests can be assured and power consumed by the system can be reduced.

(2) Implementation of the Application Server 150 With a Container or the Like

It is also possible to implement the functions of the application server 150 by using, for example, a servlet container that operates in an environment in which virtual machines are working in each server 100. In this case, when a server 100 is serviced or is controlled so as to reduce power consumption, processing by the application server 150 can be transferred to another server 100 by live migration.

(3) Division of the Session Storage Area in the Session Storage Unit 153

The storage area, in the session storage unit 153, in which session information is stored may be divided into an area intended for sessions related to requests for which it is desirable to assure an order and an area intended for sessions related to other requests. Thus, even if, for example, a large number of requests for which an order may not be assured are received from electronic devices at one moment, it is possible to process requests for which it is desirable to assure an order and requests made by persons, as is done before the a large number of requests are received.

(4) Others

It is possible to store, in a computer-readable storage medium, programs caused to execute processing intended for the Web server 140 and application server 150, which process requests received from the client apparatus 30 described above. Examples of storage media include a magnetic disk, an optical disk, a magneto-optical disk, and a semiconductor memory. Examples of magnetic disks include hard disks (HDs). Examples of optical disks include a compact disk (CD), a CD-recordable (CD-R), a CD-rewritable (CD-RW), a digital versatile disk (DVD), a DVD-recordable (DVD-R), and a DVD-rewritable (DVD-RW) disk.

Distribution of the programs in the present disclosure is not limited to distribution in the form of the recording medium described above. The programs may be used by being transmitted through an electronic communication line, a wired or wireless communication line, a network typified by the Internet, or the like and then stored in a hard disk drive (HDD) or another storage unit.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
a memory; and
a processor coupled to the memory and configured to
receive requests from a plurality of client apparatuses,
store, in the memory, information about sessions established to communicate with the plurality of client apparatuses,
store, in the memory, a request in response to which processing has not yet been started, the request being one of the requests received from the plurality of client apparatuses,
detect a session during which a predetermined time-out time has elapsed in a state in which processing demanded by a request corresponding to the session is not being executed, the session being one of the sessions, information about the sessions being stored in the memory, and
suppress, when a request received from a client apparatus corresponding to the detected session is stored in the memory, invalidation of the session due to an elapse of the time-out time.

2. The information processing system according to claim 1, wherein when the request corresponding to the session detected due to the elapse of the time-out time is not stored in the memory, the processor invalidates the session.

3. The information processing system according to claim 1, wherein the processor
stores identification information of a session corresponding to a received request until processing demanded by the received request is completed,
stores, upon reception of a request from the client apparatus, identification information of a session corresponding to the request in the memory in correspondence to the request, and
suppresses, when the identification information of the session detected due to the elapse of the time-out time is stored in the memory, the session from being invalidated.

4. The information processing system according to claim 3, wherein when processing demanded by a request corresponding to identification information stored in the memory is completed, the processor deletes the identification information from the memory, the identification information being identification information of a session corresponding to the request.

5. The information processing system according to claim 3, wherein the processor
detects a session during which the time-out time has elapsed from all sessions that have not been terminated at intervals of a predetermined period, and
invalidates, when identification information of the session detected due to the elapse of the time-out time is not stored in the memory, the session.

6. The information processing system according to claim 1, wherein the processor
stores, in the memory, first requests executed in an order in which the first requests were received,
stores, in the memory, second requests, an execution order of the second requests being variable,
calculates an estimated time taken to perform processing related to a session for each second request, the session corresponding to the each second request,
executes the first requests in the order in which the first requests were received, and
executes the second requests sequentially, starting from a request related to a session that takes a short estimated time.

7. The information processing system according to claim 1, wherein the processor
stores a different time-out time in the memory according to a type of a different client apparatus that has transmitted a request, in correspondence to identification information of the client apparatus, and
detects a time-out of a session according to the time-out time stored in the memory in correspondence to each session.

8. The information processing system according to claim 3, wherein the processor
sets, when the client apparatus issues the request upon receipt of an external input, the time-out time to a first time suitable to an interval of the external input, and
sets, when the client apparatus issues the request regardless of reception of an external input, the time-out time to a second time shorter than the first time.

9. An information processing method for an information processing apparatus including a memory and a processor coupled to the memory, comprising:
receiving requests from a plurality of client apparatuses,
storing, in the memory, information about sessions established to communicate with the plurality of client apparatuses,
storing, in the memory, a request in response to which processing has not yet been started, the request being one of the requests received from the plurality of client apparatuses,
detecting a session during which a predetermined time-out time has elapsed in a state in which processing demanded by a request corresponding to the session is not being executed, the session being one of the sessions, information about the sessions being stored in the memory, and
suppressing, when a request received from a client apparatus corresponding to the detected session is stored in the memory, invalidation of the session due to an elapse of the time-out time.
